(19) United States
(12) Patent Application Publication
(10) Pub. No.: US 2019/0365598 A1
(43) Pub. Date: Dec. 5, 2019

(54) MASSAGER WITH BRUSHLESS MOTOR

(71) Applicant: Suzhou Qinhuo Technology Co., Ltd., Suzhou (CN)

(72) Inventors: Shenlei QU, Suzhou (CN); Qiuli ZHANG, Suzhou (CN)

(21) Appl. No.: 16/429,407

(22) Filed: Jun. 3, 2019

(30) Foreign Application Priority Data
Jun. 4, 2018 (CN) 201820856515.5

(51) Int. Cl. A61H 15/00

(52) U.S. Cl. CPC A61H 15/0085; A61H 7/004

(57) ABSTRACT

The utility model discloses a massager with a brushless motor, wherein the motor is a brushless motor, an eccentric disc connected to an output shaft at the top of the brushless motor is rotatably arranged at the top of a housing, and the brushless motor and a drive circuit board at the bottom thereof and a motor fixing frame are fixed at the bottom of the inside of the housing by screws.

The use of the brushless motor can reduce noise, significantly improve the working efficiency, and enhance the endurance capability of the product; and both ends of the brushless motor are fixed with good stability, which is beneficial to the long-term operation of the machine.

### FIELD OF THE INVENTION

The utility model relates to the field of household appliances or medical equipment, and particularly to a massager with a brushless motor.

### BACKGROUND OF THE INVENTION

Massagers are a new generation of health care equipment developed according to bionics, physics, electrobiology, traditional Chinese medicine and years of clinical practice. Similar products currently on the market are provided with brush motors, which have high noise and low working efficiency.

### SUMMARY OF THE INVENTION

In order to overcome the above disadvantages, an object of the utility model is to provide a massager with a brushless motor, which is capable of reducing noise, improving the working efficiency of the motor, and significantly enhancing the endurance capability of the product.

To achieve the above object, the utility model employs the following technical solution: a massager with a brushless motor comprises motor, an eccentric disc and a link, wherein an output shaft of the motor faces upward, the output shaft is fixedly connected to the bottom of the eccentric disc, the link is sleeved on the eccentric disc and rotatably connected thereto, the motor is a brushless motor, a first bearing groove is arranged at the top of the inside of a housing, the top of the eccentric disc is arranged in the first bearing groove by a first bearing, a drive circuit board is arranged at the bottom of the brushless motor, the drive circuit board is electrically connected to the brushless motor, a motor fixing frame is arranged at the bottom of the drive circuit board, and the brushless motor, the drive circuit board and the motor fixing frame are fixed at the bottom of the inside of the housing by motor locking screws.

The utility model has the following beneficial effects: the use of the brushless motor instead of a brush motor can significantly reduce the noise of the product, significantly improve the working efficiency of the motor, and enhance the endurance capability of the product; and an upper end of the motor is positioned by the cooperation between the first bearing and the first bearing groove, a lower end of the motor is positioned by the cooperation between the motor locking screws and the motor fixing frame, and the both ends of the motor are fixed with good stability, which is beneficial to the long-term operation of the machine, thus increasing the service life.

Preferably, two said eccentric discs are arranged, upper and lower corresponding connecting posts are integrally formed at one side of opposite end faces of two said eccentric discs, the upper and lower corresponding connecting posts are fixed by a screw, a left end of the link is sleeved on the corresponding connecting posts by a second bearing, the left end of the link can be rotated relative to the connecting posts, the output shaft of the brushless motor is fixedly connected to the bottom of the lower eccentric disc, and the motor can drive the two eccentric discs to rotate. The two eccentric discs are located above and below the link so that the link can move more stably.

Preferably, a connecting rod for positioning is arranged at a right end of the link, the link is rotatably connected to the connecting rod, and the connecting rod can move leftward and rightward. The connecting rod is used to ensure that the link can reciprocate.

Preferably, a massage member is arranged at the right end of the link, the massage member includes a reciprocating rod, a reciprocating rod sleeve and a massage head, a left end of the reciprocating rod is rotatably connected to the connecting rod, a right end of the reciprocating rod is connected to the massage head, the reciprocating rod sleeve is fixed on the housing, and the reciprocating rod can slide leftward and rightward in the reciprocating rod sleeve. When the reciprocating rod moves leftward and rightward along with the link, the massage head also moves leftward and rightward, and the massage effect of the massage head is achieved by the reciprocating motion. The reciprocating rod sleeve defines the leftward and rightward traveling trajectory of the reciprocating rod, and also defines the leftward and rightward moving trajectory of the connecting rod.

Preferably, a right end of the massage head is in a shape which includes, but is not limited to, a spherical shape, a conical shape or other shapes suitable for different joints, so that the massage is more comfortable; and the massage head is detachably connected to the reciprocating rod, and hence can be replaced as needed.

Preferably, fixing holes are evenly distributed along the same circumference, and the number of the fixing holes is not limited as long as fixing can be achieved.

Preferably, the motor is a brushless Hall outer rotor motor or a brushless Hall-less outer rotor motor.

Preferably, a rubber ring is arranged between the reciprocating rod and the massage head, and the rubber ring is clamped at a clamping slot of a handle of the massage head.

Preferably, the reciprocating rod is made of metal, and the reciprocating rod sleeve is made of wear-resistant plastic, which is beneficial to increasing the service life of the reciprocating rod and the reciprocating rod sleeve, and lubricating oil can be dispensed with.

### BRIEF DESCRIPTION OF THE DRAWINGS

The drawings are used to provide a further understanding of the utility model and constitute a part of the description, and are used for explaining the utility model together with the embodiments of the utility model, but do not limit the utility model. In the Figures:

FIG. 1 is a cross-sectional view of the present embodiment;

FIG. 2 is a perspective view of a first angle after a housing is disassembled in the present embodiment;

FIG. 3 is a perspective view of another angle after the housing is disassembled in the present embodiment; and

FIG. 4 is an exploded view of the cooperation between a reciprocating rod and a massage head in the present embodiment.

### DETAILED DESCRIPTION OF THE INVENTION

The preferred embodiments of the present embodiment will be described below in detail with reference to the drawings so that the advantages and features of the present embodiment can be more easily understood by those skilled in the art, thus the protection scope of the present embodiment is more clearly and definitely defined.

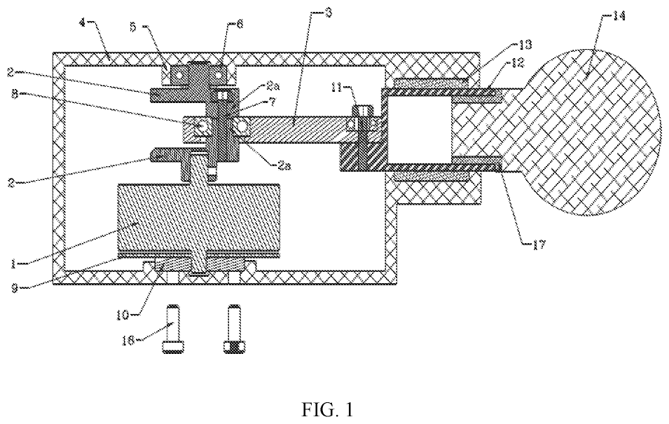

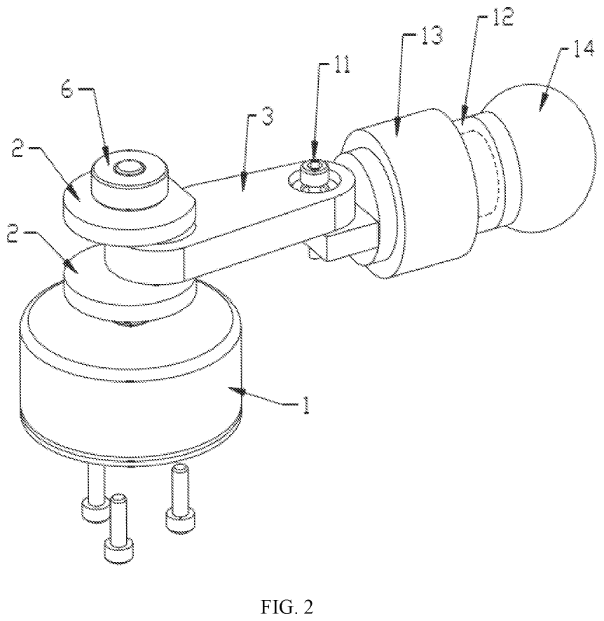

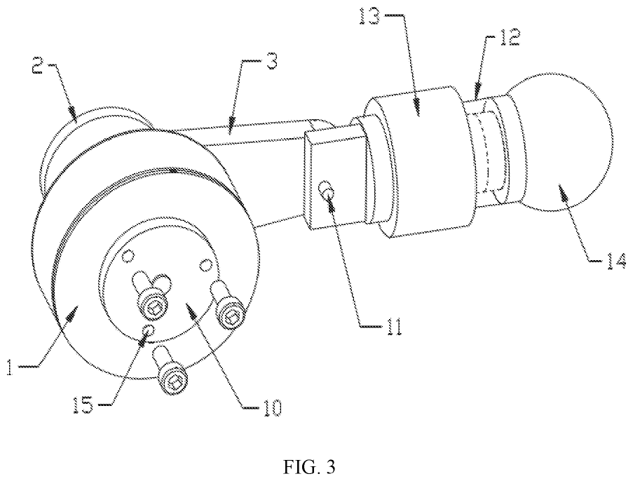

As shown in FIGS. 1 to 3, the present embodiment provides a massager with a brushless motor, which comprises a motor 1, an eccentric disc 2 and a link 3, wherein an output shaft of the motor 1 faces upward, the output shaft is fixedly connected to the bottom of the eccentric disc 2, the link 3 is sleeved on the eccentric disc 2 and rotatably connected thereto, and the motor 1 is a brushless motor. More specifically, the brushless motor is a brushless Hall outer rotor motor or a brushless Hall-less outer rotor motor. A first bearing groove 5 is arranged at the top of the inside of a housing 4, the top of the eccentric disc 2 is arranged in the first bearing groove 5 by a first bearing 6, a drive circuit board 9 is arranged at the bottom of the brushless motor, the drive circuit board 9 is electrically connected to the brushless motor, a motor fixing frame 10 is arranged at the bottom of the drive circuit board 9, and the brushless motor, the drive circuit board 9 and the motor fixing frame 10 are fixed at the bottom of the inside of the housing 4 by motor locking screws 16.

Two said eccentric discs 2 are arranged, upper and lower corresponding connecting posts 2a are integrally formed at one side of opposite end faces of two said eccentric discs 2, the upper and lower corresponding connecting posts 2a are fixed by a screw 7, a left end of the link 3 is sleeved on the corresponding connecting posts 2a by a second bearing 8, the left end of the link 3 can be rotated relative to the connecting posts 2a, the output shaft of the brushless motor is fixedly connected to the bottom of the lower eccentric disc 2, and the motor 1 can drive the two eccentric discs 2 to rotate. A connecting rod 11 for positioning is arranged at a right end of the link 3, the link 3 is rotatably connected to the connecting rod 11, and the connecting rod 11 can move leftward and rightward. In the present embodiment, the diameter of the left end of the link 3 is greater than that the right end thereof, and the link 3 can provide a smooth support.

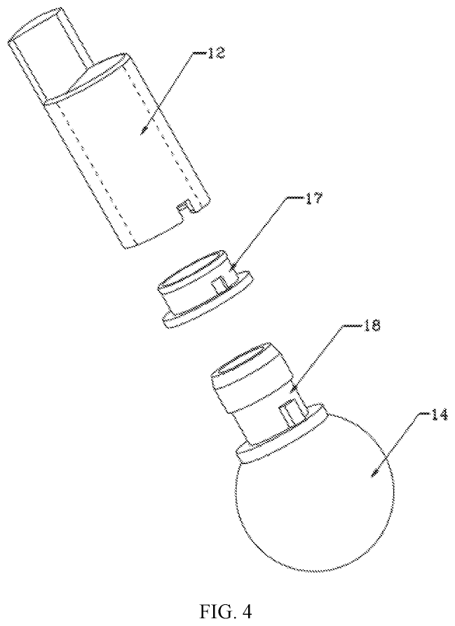

A massage member is arranged at the right end of the link 3, the massage member includes a reciprocating rod 12, a reciprocating rod sleeve 13 and a massage head 14, a left end of the reciprocating rod 12 is rotatably connected to the connecting rod 11, and a right end of the reciprocating rod 12 is connected to the massage head 14. Specifically, as shown in FIG. 4, a rubber ring 17 is arranged between the reciprocating rod 12 and the massage head 14, and the rubber ring 17 is clamped at a clamping slot 18 of a handle of the massage head 14. A right end of the massage head 14 is in a shape which includes, but is not limited to, a spherical shape, a conical shape or other shapes suitable for different joints, so that the massage is more comfortable; and the massage head 14 is detachably connected to the reciprocating rod 12, and hence can be replaced as needed. The reciprocating rod sleeve 13 is fixed on the housing 4, and the reciprocating rod 12 can slide leftward and rightward in the reciprocating rod sleeve 13. The reciprocating rod 12 is made of metal, and the reciprocating rod sleeve 13 is made of wear-resistant plastic. The right end of the massage head 14 is spherical.

The motor fixing frame 10 has at least three fixing holes 15. In the present embodiment, three fixing holes 15 are arranged, the number of the fixing holes 15 is reduced under the premise of ensuring the fixing stability, and the three fixing holes 15 are evenly distributed along the same circumference.

The above embodiments are only for the purpose of describing the technical concept and features of the utility model, and aim at enabling the persons skilled in the art to understand and implement the contents of the present embodiment, and therefore cannot limit the protection scope of the present embodiment. Any equivalent change or modification made based on the spirit and essence of the present embodiment shall be covered within the protection scope of the present embodiment.

1. A massager with a brushless motor, comprising a motor (1), an eccentric disc (2) and a link (3), an output shaft of the motor (1) facing upward, the output shaft being fixedly connected to the bottom of the eccentric disc (2), and the link (3) being sleeved on the eccentric disc (2) and rotatably connected thereto, wherein the motor (1) is a brushless motor, a first bearing groove (5) is arranged at the top of the inside of a housing (4), the top of the eccentric disc (2) is arranged in the first bearing groove (5) by a first bearing (6), a drive circuit board (9) is arranged at the bottom of the brushless motor, the drive circuit board (9) is electrically connected to the brushless motor, a motor fixing frame (10) is arranged at the bottom of the drive circuit board (9), and the brushless motor, the drive circuit board (9) and the motor fixing frame (10) are fixed at the bottom of the inside of the housing (4) by motor locking screws (16).

2. The massager with a brushless motor according to claim 1, wherein two said eccentric discs (2) are arranged, upper and lower corresponding connecting posts (2a) are integrally formed at one side of opposite end faces of two said eccentric discs (2), the upper and lower corresponding connecting posts (2a) are fixed by a screw (7), a left end of the link (3) is sleeved on the corresponding connecting posts (2a) by a second bearing (8), the left end of the link (3) can be rotated relative to the connecting posts (2a), the output shaft of the brushless motor is fixedly connected to the bottom of the lower eccentric disc (2), and the motor (1) can drive the two eccentric discs (2) to rotate.

3. The massager with a brushless motor according to claim 2, wherein a connecting rod (11) for positioning is arranged at a right end of the link (3), the link (3) is rotatably connected to the connecting rod (11), and the connecting rod (11) can move leftward and rightward.

4. The massager with a brushless motor according to claim 3, wherein a massage member is arranged at the right end of the link (3), the massage member includes a reciprocating rod (12), a reciprocating rod sleeve (13) and a massage head (14), a left end of the reciprocating rod (12) is rotatably connected to the connecting rod (11), a right end of the reciprocating rod (12) is connected to the massage head (14), the reciprocating rod sleeve (13) is fixed on the housing (4), and the reciprocating rod (12) can slide leftward and rightward in the reciprocating rod sleeve (13).

5. The massager with a brushless motor according to claim 4, wherein the massage head (14) is detachably connected to the reciprocating rod (12).

6. The massager with a brushless motor according to claim 1, wherein fixing holes (15) are evenly distributed along the same circumference.

7. The massager with a brushless motor according to claim 1, wherein the motor is a brushless Hall outer rotor motor or a brushless Hall-less outer rotor motor.

8. The massager with a brushless motor according to claim 4, wherein a rubber ring (17) is arranged between the reciprocating rod (12) and the massage head (14), and the rubber ring (17) is clamped at a clamping slot (18) of a handle of the massage head (14).

9. The massager with a brushless motor according to claim 1, wherein the reciprocating rod (12) is made of metal, and the reciprocating rod sleeve (13) is made of wear-resistant plastic.
